(19) United States
(12) Patent Application Publication
(10) Pub. No.: US 2014/0012597 A1
(43) Pub. Date: Jan. 9, 2014

(54) AUTOMATICALLY POPULATING A WHITEBOARD WITH AGGREGATE DATA

(71) Applicants: MARK NOLTE, Lee's Summit, MO (US); ERIC KAYS, Olathe, KS (US); RAJNEESH MEHRA, Overland Park, KS (US); JOHN VOLKENS, Overland Park, KS (US); CASSIE LYN BAHR, Prairie Village, KS (US)

(72) Inventors: MARK NOLTE, Lee's Summit, MO (US); ERIC KAYS, Olathe, KS (US); RAJNEESH MEHRA, Overland Park, KS (US); JOHN VOLKENS, Overland Park, KS (US); CASSIE LYN BAHR, Prairie Village, KS (US)

(73) Assignee: CERNER INNOVATION, INC., Overland Park, KS (US)

(21) Appl. No.: 13/543,282

(22) Filed: Jul. 6, 2012

(51) Int. Cl. G06Q 50/24

(52) U.S. Cl. CPC G06Q 50/24
USPC 705/3

(57) ABSTRACT

Systems, methods, computer-readable media, and graphical user interfaces for automatically populating a dashboard with aggregate data are provided. In embodiments, a dashboard associated with a plurality of rooms in a hospital unit is displayed on a touchscreen monitor. Unit data associated with the plurality of rooms including unit description, current shift, charge nurse, clinician names, and clinician numbers is received. Patient data associated with a patient in each of the plurality of rooms is received. The patient data includes location, name, sex, age, and length of stay. The dashboard is automatically populated in real-time with the unit data and the patient data. One or more alerts associated with a patient in one of the plurality of rooms are received. One or more visual cues associated with one or more alerts are displayed on the dashboard.

### BACKGROUND

Shift assignments are often provided in a hospital unit on a whiteboard. The whiteboard is manually updated to provide employees of the unit information needed to provide care to the patients within that unit. In some instances, the information provided includes clinician numbers, special notification related to a patient, charge nurse information, and resident information. Unfortunately, the time required to manually update the whiteboard results in a decreased time to provide patient care. In addition, information included by manual updates is often limited and prone to human error.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to methods, systems, and computer readable media for facilitating a method of automatically populating a dashboard. In one embodiment, computer storage media having computer-executable instructions embodied thereon that, when executed, facilitate a method of automatically populating a dashboard. A dashboard associated with a plurality of rooms in a hospital unit is displayed on a touchscreen monitor. Unit data associated with the plurality of rooms including unit description, current shift, charge nurse, clinician names, and clinician numbers is received. Patient data associated with a patient in each of the plurality of rooms is received. The patient data includes location, name, sex, age, and length of stay. The dashboard is automatically populated in real-time with the unit data and the patient data.

In another embodiment, a computer system, comprising a processor coupled to a computer storage medium, the computer storage medium having stored thereon a plurality of computer software components executable by the processor, for automatically populating a dashboard is provided. A display component displays, on a touchscreen monitor, a dashboard associated with a plurality of rooms in a hospital unit. An aggregate component receives aggregate data associated with the plurality of rooms. A population component automatically populates the dashboard, in real-time, with the aggregate data. An alert component receives one or more alerts associated with a patient in one of the plurality of rooms. A visual cue component displays one or more visual cues, on the dashboard, associated with the one or more alerts.

In another embodiment, computer storage media having computer-executable instructions embodied thereon that, when executed, produce a graphical user interface (GUI) to facilitate utilizing an automatically populated dashboard. A first display area is configured to display a dashboard associated with a plurality of rooms in a hospital unit. A second display area is configured to display aggregate data associated with the plurality of rooms including unit description, current shift, charge nurse, clinician names, and clinician numbers. A third display area is configured to display a keypad for providing comments. A fourth display area is configured to display a set of filters that can be used to filter the dashboard to display only those rooms in accordance with a selected filter. A fifth display area is configured to display a header associated with one of the plurality of rooms including a room location and the name, sex, and length of stay of a patient. A sixth display area is configured to display caregivers associated with one of the plurality of rooms. A seventh display area is configured to display allergies associated with the patient. An eighth display area is configured to display care priorities associated with the patient. A ninth display area is configured to display a diagnosis associated with the patient. A tenth display area is configured to display alert history associated with the patient.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is an exemplary system architecture suitable for use in implementing embodiments of the present invention;

FIG. 3 is a flow diagram of a method in accordance with an embodiment of the present invention; and

FIGS. 4-5 are illustrative screen displays in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Having briefly described embodiments of the present invention, an exemplary operating environment suitable for use in implementing embodiments of the present invention is described below.

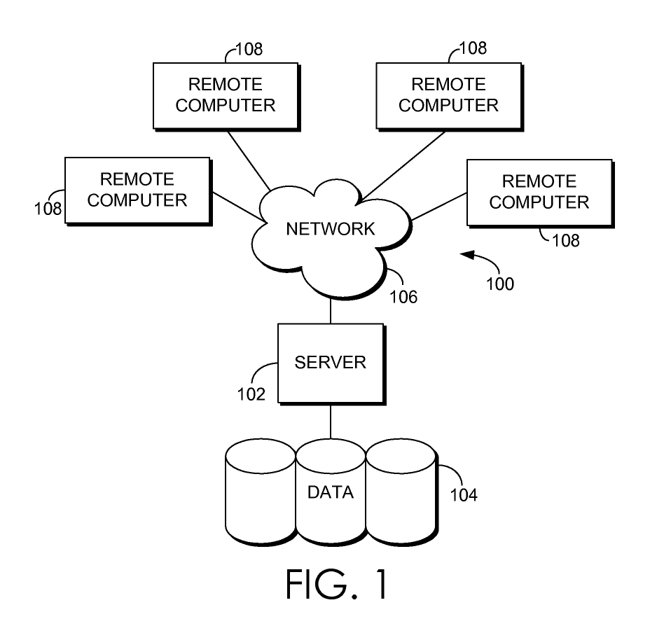

Referring to the drawings in general, and initially to FIG. 1 in particular, an exemplary computing system environment, a medical information computing system environment, with which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary medical information computing system environment 100 includes a general purpose computing device in the form of a control server 102. Components of the control server 102 may include, without limitation, a processing unit, internal system memory, and a suitable system bus for coupling various system components, including database cluster 104, with the control server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 102. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the control server 102. The control server 102 may operate in a computer network 106 using logical connections to one or more remote computers 108. Remote computers 108 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as intensivists, surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the elements described above in relation to the control server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the control server 102 may include a modem or other means for establishing communications over the WAN, such as the Internet. In a networked environment, program modules or portions thereof may be stored in association with the control server 102, the database cluster 104, or any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) may be utilized.

In operation, a clinician may enter commands and information into the control server 102 or convey the commands and information to the control server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 102. In addition to a monitor, the control server 102 and/or remote computers 108 may include other peripheral output devices, such as speakers and a printer.

Although many other internal components of the control server 102 and the remote computers 108 are not shown, those of ordinary skill in the art will appreciate that such components and their interconnection are well known. Accordingly, additional details concerning the internal construction of the control server 12 and the remote computers 18 are not further disclosed herein.

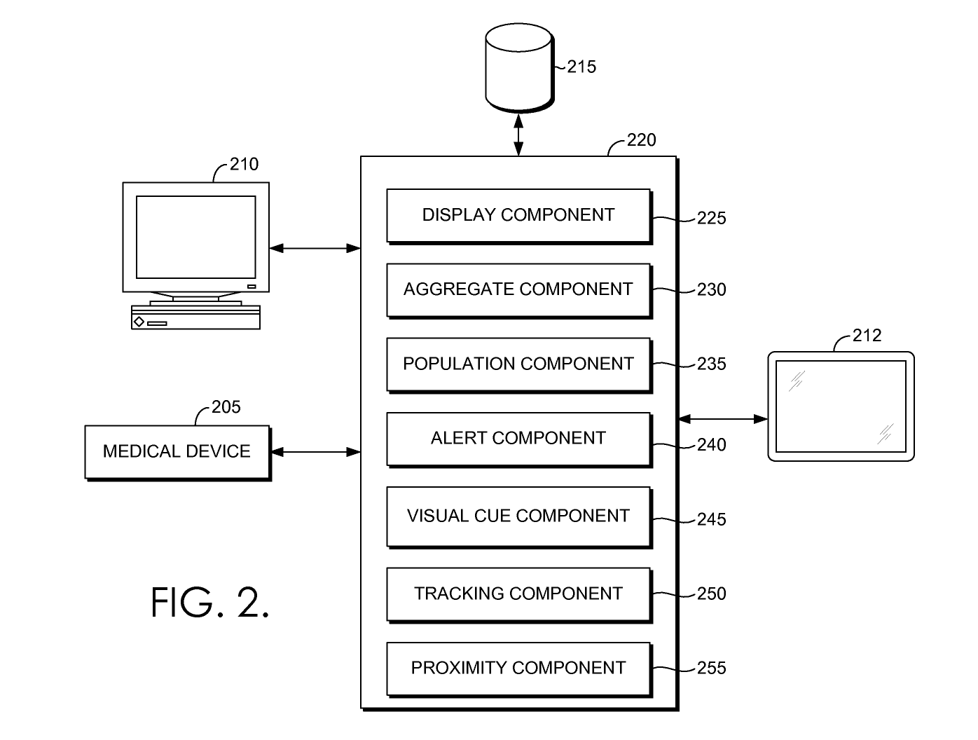

With reference to FIG. 2, a block diagram is illustrated that shows an exemplary computing system architecture for automatically populating a dashboard. It will be appreciated that the computing system architecture shown in FIG. 2 is merely an example of one suitable computing system and is not intended as having any dependency or requirement related to any single module/component or combination of modules/components.

The computing system includes one or more medical devices 205, dashboard 212, datastore 215, and automated dashboard module 220. Data elements are received from medical devices 205. A medical device 205 may be any device, stationary or otherwise, that may be used to treat, diagnose, monitor, or measure aspects of a patient in a hospital, doctor's office, etc. For exemplary purposes only and not limitation, medical devices include cardiac monitors, cardiac output monitors, ICP monitors, ventilators, pumps (e.g., infusion pumps, balloon pumps), and the like. As such, these medical devices generate various data (e.g., heart-rate changes) that is communicated to datastore 215.

Datastore 215 contains a variety of information data for the patient in a patient's electronic medical record (EMR) as well as staff information (i.e., names, numbers, and tracking data) associated with a unit and alert information associated with the patients. As utilized herein, the acronym “EMR” is not meant to be limiting, and may broadly refer to any or all aspects of the patient's medical record rendered in a digital format. Generally, the EMR is supported by systems configured to co-ordinate the storage and retrieval of individual records with the aid of computing devices. As such, a variety of types of healthcare-related information may be stored and accessed in this way. By way of example, the EMR may store one or more of the following types of information: patient demographic; medical history (e.g., examination and progress reports of health and illnesses); medicine and allergy lists/immunization status; laboratory test results, radiology images (e.g., X-rays, CTs, MRIs, etc.); evidence-based recommendations for specific medical conditions; a record of appointments and physician's notes; billing records; and data received from an associated medical device. Accordingly, systems that employ EMRs reduce medical errors, increase physician efficiency, and reduce costs, as well as promote standardization of healthcare. Dashboard 212 may be a touchscreen monitor, computer screen, project device or other hardware device for displaying output and capable of displaying graphical user interfaces.

Automated dashboard module 220 receives and displays data from datastore 215 and/or one or more medical devices 205 on the dashboard 212 for a hospital unit. Automated dashboard module 220 may reside on one or more computing devices, such as, for example, the control server 102 described above with reference to FIG. 1. By way of example, the control server 102 includes a computer processor and may be a server, personal computer, desktop computer, laptop computer, handheld device, mobile device, consumer electronic device, or the like. Automated dashboard module 220 comprises display component 225, aggregate component 230, population component 235, alert component 240, visual cue component 245, tracking component 250, and proximity component 255.

Display component 225 displays, on touchscreen monitor 212, a dashboard associated with a unit view or a plurality of rooms in a hospital unit. In one embodiment, a summary view is initially displayed by display component 225. The summary view may include a grid view of all rooms in the unit. In one embodiment, the summary view provides a default view. For example the grid view may display forty rooms on a single screen. For any location not occupied, the display may indicate that the location does not have a patient. In one embodiment, the grid view is dynamic and scalable of each depending on the number of locations (i.e., rooms) in a hospital unit and the status of each room. For example, a hospital unit may have 24 rooms. In one embodiment, the summary view depicts a grid with six rows and four columns to display each of the 24 rooms. However, only 20 of the 24 rooms might be occupied at any given time.

In one embodiment, display component dynamically adjusts the grid view to contain five rows and four columns.

In another embodiment, display component 225 acknowledges that certain rooms may be utilized by a hospital as swing rooms. Swing rooms may be utilized by more than one unit depending on need. Display component 225 recognizes which unit is currently utilizing a swing room and displays the swing room in the appropriate dashboard. This recognition may be based on information received by aggregate component 230, alert component 240, visual cue component 245, tracking component 250, proximity component 255, or any combination thereof. In one embodiment, display component 225 also allows a user of the dashboard to view additional details for a given room in a more detailed view. In one embodiment, display component 225 provides the ability to zoom in and out, allowing a user to customize the size of the location.

Aggregate component 230 receives aggregate data associated with the plurality of rooms. Aggregate component 230 receives the aggregate data from datastore 215 and/or one or more medical devices 205. In one embodiment, aggregate data receives aggregate data from other systems that receive, collect, or transmit data associated with a patient (e.g., admit, discharge, and transfer systems), a device, a clinician (e.g., clinician tracking or proximity detection systems), a location, a treatment, a medication, and the like. In various embodiments, the aggregate data includes unit description, current shift, charge nurse, clinician names, clinician numbers, location, patient name, patient sex, patient age, length of stay, special care indicators, information received by devices, alerts, or any combination thereof. As noted above, the aggregate data received by aggregate component 230 is processed by display component 225 to recognize which unit a given room is associated with.

In one embodiment, a header is displayed on the dashboard including a unit description, current shift, and current charge nurse. In one embodiment, aggregate component 230 receives information for each location, including patient name, primary clinician and number, alerts, and special care indicators. In one embodiment, display component 225 provides a user the ability to define how particular information received by aggregate component 230 is displayed. For example, a user may wish to customize how items such as location, patient name, primary clinician name and number appear on the dashboard. In one embodiment, a user may determine how many primary clinicians are displayed for a particular patient. For example, if multiple primary clinicians are associated with the patient, a user may desire to specify that only a single primary clinician should be displayed on the dashboard. In this example, display component 225 receives an indication from the user specifying how many clinicians to display on the dashboard. Display component 225 also displays a notation indicating how many primary clinicians are associated with that patient.

Population component 235 automatically populates the dashboard, in real-time, with the aggregate data. For clarity, real-time includes near real-time, taking into account latency or other typical delays between one or more devices communicating in a networked environment. As noted above, display component 225 provides a user the ability to customize or modify the appearance of the dashboard, including what types of aggregate data are displayed. This customization information is communicated by display component 225 to population component 235. As aggregate data is communicated to population component 235 from aggregate component 230, the aggregate data is filter in accordance with the customization information.

In one embodiment, the dashboard allows manual entry. For instance, the current charge nurse information may need to be updated based on census or other circumstances. Even though aggregate component 230 receives information regarding the current charge nurse, population component 235 provides the ability to enter the charge nurse manually from the dashboard. In one embodiment, the dashboard provides a free form comment section. This section may be displayed or not displayed based on user or unit preference. In one embodiment, the free form comment section allows headers and details related to comments to be entered. In one embodiment, the comments are separated according to type or time and may include an audit trail. The audit trail may be accomplished utilizing proximity detection of the user or a tracking system associated with the clinicians. In one embodiment, the comments are entered directly into the dashboard (i.e., does not require a separate workstation) utilizing the touchscreen associated with the dashboard.

In one embodiment, private or confidential data received by aggregate component 230 is partially or fully masked by population component 235. In one embodiment, private or confidential data received by aggregate component 230 is not populated by population component 235. Such masking or screening may be accomplished, in one embodiment, by a rules engine in communication with population component 235. In another embodiment, a user may manually mask or remove a portion of the aggregate data from the dashboard. In another embodiment, the dashboard may recognize the user by way of proximity detection or by receiving tracking information for the particular user and may automatically mask or unmask a portion of the aggregate data based on credentials associated with that user. In another embodiment, confidential details are unmasked based on credentials provided by the user. In one embodiment, the credentials provided by the user are by proximity detection, bioscan, fingerprint, or any other unique identifier.

Alert component 240 receives one or more alerts associated with a patient in one of the plurality of rooms. In one embodiment, one or more alerts are received by aggregate component 230 and communicated to alert component 240. Alert component 240 communicates one or more alerts, in one embodiment, along with display rules to population component 235. The display rules allow the alerts to be displayed according to the rules of the device communicating the alerts. For example, a particular device may have definitions for particular alerts to display an alert persistently, in a certain color, for a certain period of time, or in a particular manner (e.g., flashing). The display rules allow the dashboard to display the alert according to the definitions.

In one embodiment, one or more alerts are displayed until acknowledged by a user or until a timeout period has been reached. In one embodiment, one or more alerts are persistent until corrective action is taken or a clinician or device determines the alert is no longer active. In another embodiment, an alert is displayed until acknowledged by a user, until a timeout period has been reached, or until a higher priority alert is received by alert component 240. In one embodiment, the dashboard is configurable allowing a user to define whether a particular alert should be displayed in a unit view dashboard and/or a patient view dashboard. For example, a particular unit may want to have a high priority alert displayed on the unit view dashboard so the alert receives immediate attention. A lower priority alert may not require immediate attention and is only displayed on the patient view dashboard.

Visual cue component 245 displays, on the dashboard, one or more visual cues associated with the one or more alerts. In another embodiment, visual cue component displays, on the dashboard, special care indicators. Special care indicators may include observation, core measure, telemetry, falls risk, nil per os (NPO), code status, length of stay, correction/prisoner, restraints, sitter, transplant, disability, skin risk, duplicate name, and the like. In one embodiment, special care indicators are created and defined based on the location or unit. For example, a burn unit may have different types of special care than a labor and delivery unit. Each unit may desire to create and define custom special care indicators to accommodate the various needs and types of care for that particular unit.

In one embodiment, the special care indicators are associated with special rules related to the display of the location to alert the clinician in multiple ways (e.g., when a duplicate name icon exists, change the location box blue). In one embodiment, an importance order is configurable for the special care indicators. For example, a clinician or unit may determine that one particular special care indicator has a higher priority and needs to be displayed above or more prominently than other special care indicators. In one embodiment, the special care indicators display is configurable to define a maximum number of special care indicators that are displayed at a given time. In this instance, a special icon to visually notify a clinician that additional special care indicators exist is displayed. In one embodiment, the unit view displays locations based on the special care indicators. For example, a clinician may desire to display only locations with a particular special care indicator. The clinician selects the desired special care indicator and display component 225 filters the display so that only locations associated with the selected special care indicator are displayed.

In one embodiment, tracking component 250 visually tracks, utilizing the dashboard, clinicians associated with the hospital unit. The tracking component 250 may track the clinician in a variety of manners. Healthcare resources such as clinicians, patients, equipment, clinical devices, and the like may be tracked via a plurality of sensors in the healthcare environment. The sensors in the healthcare environment may utilize ultrasound technology, infrared technology, radio-frequency identification technology, and the like. Using said technology, the sensors send out signals to clinician identifiers, patient identifiers, item identifiers, clinical device identifiers, or the like. An exemplary sensor system is the Cricket Indoor Location System sponsored by the MIT Project Oxygen partnership.

The signals are received by the identifiers and the identifiers respond to the signals. A response from an identifier is received by the sensors and the sensors are able to recognize and determine the location of the responding identifier and, thus, are aware of the resources within the healthcare environment. The respective identifiers associated with the resources may be located, e.g., on the person, on the item, or on the device. Exemplary identifiers include badges, wristbands, tags, and the like. The locations of clinicians, patients, equipment, or the like, associated with a responding identifier, is presented or displayed on the dashboard.

In one embodiment, the presence of the clinicians, patients, clinical devices, or the like, is useful when determining what type of information is displayed on the dashboard. Additionally, the presence information may be used in combination with clinical information from an EMR or with an alert presented based on clinical information, location information, clinical device information, or a combination thereof. For example, in one embodiment, the display or alerts may be tailor in response to the presence of a certain individual, based upon the responsibilities (i.e., display patients or alerts associated with the patients that particular clinician is responsible for) or credentials of that individual. In another embodiment, proximity component 255 enables viewing of confidential data based on credentials associated with a user in proximity of the dashboard.

As described briefly above, one embodiment, a detail or location screen is displayed when an individual location is selected. This provides a more detailed view of a single location's information than is displayed on the unit view screen. In a unit where more than one patient share a particular location, a patient screen can be selected from the location screen to provide a more detailed view of a single patient's information than is displayed on the location screen. In one embodiment, the location screen has a close option to return to the unit view screen. In one embodiment, the location screen automatically returns to the unit view screen when proximity component 255 detects the clinician who selected the location screen is no longer in proximity of the dashboard. In one embodiment, the location screen automatically returns to the unit view screen after a configurable amount of time has been exceeded (i.e., a timeout set by a user).

In one embodiment, the location screen includes a header that displays the location, name (in the same format as the unit view screen), sex, age, and length of stay. In one embodiment, primary and secondary providers for the patient associated with the location are displayed. In one embodiment, diagnosis information related to the patient associated with the location is displayed. In one embodiment, all special care indicators related to the patient associated with the location are displayed. In one embodiment, the alerts displayed on the unit view screen that are associated with the patient associated with the location are displayed. In one embodiment, a summary listing of alerts by type related to the patient associated with the room is displayed. In one embodiment, the summary listing of alerts can be filtered according to a selected time frame. In one embodiment, the location screen streamlines shift change by providing all necessary information to the incoming clinician. In one embodiment, the location screen allows a user to send a message to all clinician associated with a particular location or patient. In one embodiment, a patient may communicate a message to a comment portion of the location screen.

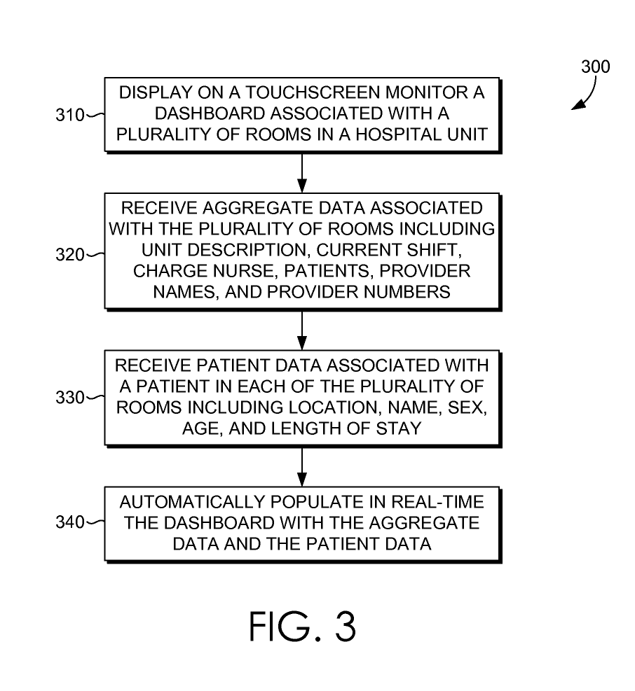

Referring now to FIG. 3, an illustrative flow diagram 300 is shown of a method in accordance with embodiments of the present invention. At step 310, a dashboard associated with a plurality of rooms in a hospital unit is displayed on a touchscreen monitor. Aggregate data associated with the plurality of rooms is received at step 320. The aggregate data includes unit description, current shift, charge nurse, patients, provider names, and provider numbers. At step 330, patient data associated with a patient in each of the plurality of rooms is received. The patient data includes location, name, sex, age, and length of stay. The dashboard, at step 340, is automatically populated, in real-time, with the aggregate data and the patient data.

In one embodiment, a diagnosis associated with a patient in each of the plurality of rooms is displayed. In one embodiment, the diagnosis is only displayed on the patient or location screen. In one embodiment, the diagnosis is displayed for each patient on the unit view. In one embodiment, the diagnosis is only displayed for each patient on the unit view when the appropriate credentials are provided.

In one embodiment, a request is for additional information for one of the plurality of rooms is received. If the request is allowed, or if the request is received from a user with appropriate credentials, the location or patient screen opens and additional information is displayed.

In one embodiment, an assignment to the hospital unit for a swing room is received. This assignment allows the swing room to be utilized by more than one unit, depending on needs or census. Accordingly, the swing room will be displayed in the appropriate unit by the dashboard in the unit view.

In one embodiment, a scalable view of the dashboard is provided. In one embodiment, the scalable view is automatically scaled in accordance with a number of the plurality of rooms associated with the hospital unit. This allows the unit view to fit the display of the dashboard. For example, if a unit has 20 rooms, the view may be represented by five rows of four rooms. If the unit has 64 rooms, the view may be represented by eight rows of eight rooms.

In one embodiment, the clinicians may be visually tracked utilizing the dashboard. The clinician may be tracked utilizing any means such as proximity or presence detection, ultrasound technology, infrared technology, radio-frequency identification technology, and the like. An indicator may be displayed on the unit view, location view, or patient view when a clinician is in a particular location. Such an indicator may assist other clinicians when trying to locate the tracked clinician.

In one embodiment, confidential data is masked on the dashboard. In one embodiment, viewing of confidential data is enabled based on credentials associated with a user in proximity of the dashboard. In one embodiment, a comment section is provided, utilizing a keypad on the touchscreen display.

In one embodiment, one or more alerts associated with a patient in one of the plurality of rooms are received. One or more visual cues associated with the one or more alerts, in one embodiment, are presented. In one embodiment, the one or more alerts are device alerts or special care indicators. In one embodiment, special rules, based on location and importance, related to the display on the dashboard of alerts are received. In one embodiment, a summary listing of alerts by type related to each patient in the hospital unit is displayed according to a selected timeframe.

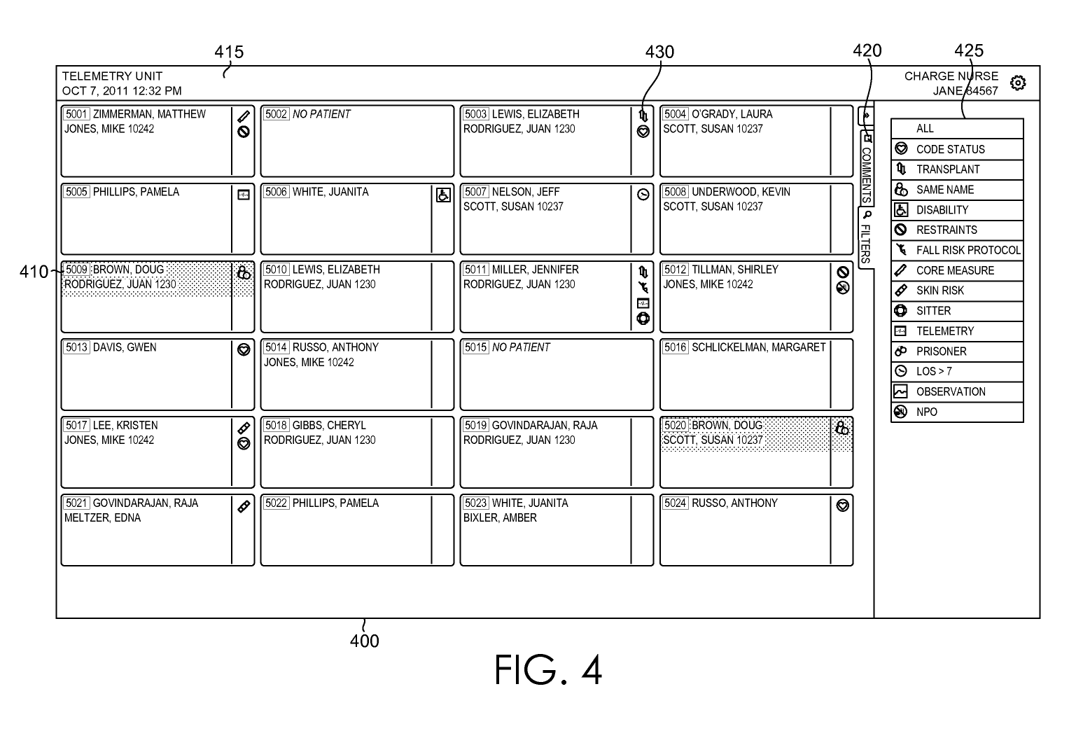

Referring now to FIG. 4, in an illustrative screen display 400, a first display area 410 displays a dashboard associated with a plurality of rooms in a hospital unit, as described above. A second display area 415 displays aggregate data associated with the plurality of rooms. The aggregate data includes unit description, current shift, charge nurse, patient data, clinician names, and clinician number. A comment section is configured to display comments in a third display area 420. The comments may be entered via a keypad that opens on the touchscreen when the comment section is selected. A fourth display area 425 displays a set of filters that can be used to filter the dashboard to display only those rooms in accordance with a selected filter. For example, a clinician may wish to display all locations associated with transplant patients. Upon selecting the transplant filter, only those locations are displayed by the dashboard. In one embodiment, an eleventh display area 430 displays visual cues associated with the plurality of rooms. For example, a visual cue may indicate that a patient in a particular location is a transplant location. The visual cue allows a clinician to quickly assimilate characteristics associated with each patient in the plurality of rooms.

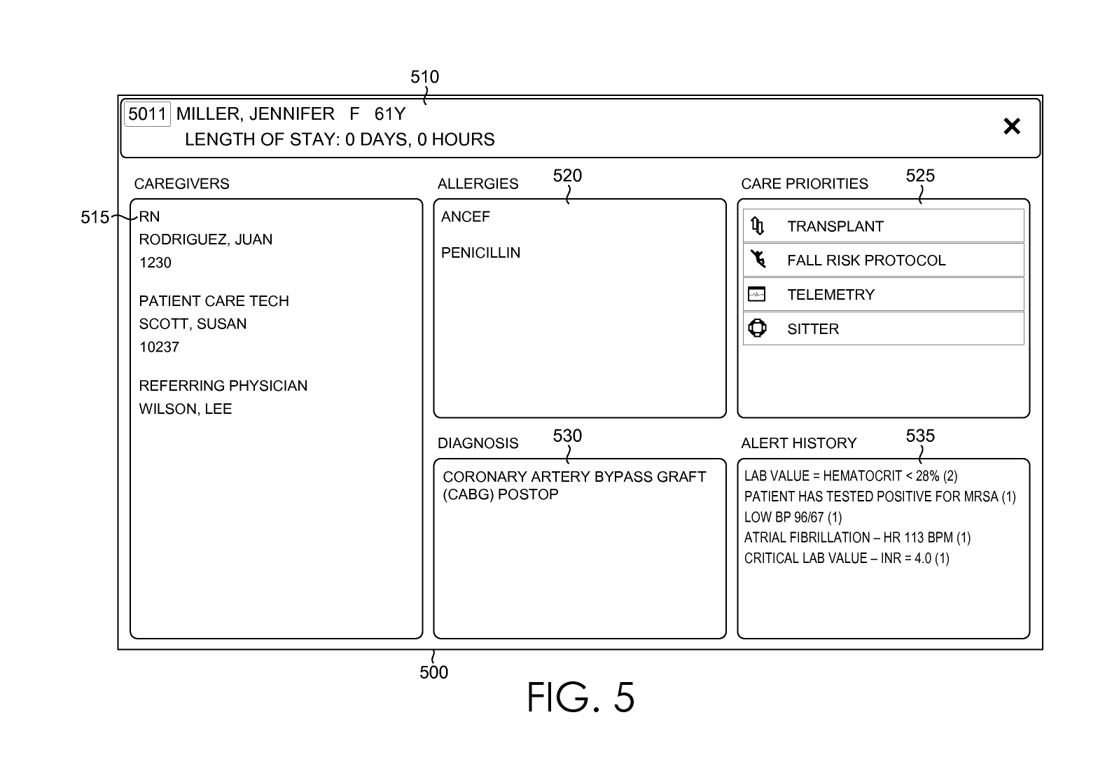

Referring now to FIG. 5, in an illustrative screen display 500, a fifth display area 510 displays a header associated with one of the plurality of rooms. The header includes a room location and the name, sex, age, and length of stay of a patient. Caregivers associated with one of the plurality of rooms are displayed in a sixth display area 515. A seventh display 520 area displays allergies associated with the patient. Care priorities associated with the patient are displayed in an eighth display area 525. The care priorities include observation, core measure, telemetry, falls risk, nil per os (NPO), code status, length of stay, correction/prisoner, restraints, sitter, transplant, disability, skin risk, duplicate name, and the like. In one embodiment, care priorities are created and defined based on the location or unit. For example, a burn unit may have different types of care priority than a labor and delivery unit. Each unit may desire to create and define custom care priorities to accommodate the various needs and types of care for that particular unit. A ninth display area 530 displays a diagnosis associated with the patient. An alert history associated with the patient is displayed in a tenth display area 535.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer storage media having computer-executable instructions embodied thereon, that when executed, facilitates a method of automatically populating a dashboard, the method comprising:
displaying on a touchscreen monitor a dashboard associated with a plurality of rooms in a hospital unit;
receiving aggregate data associated with the plurality of rooms including unit description, current shift, charge nurse, clinician names, and clinician numbers;
receiving patient data associated with a patient in each of the plurality of rooms including location, name, sex, age, and length of stay; and
automatically populating in real-time the dashboard with the aggregate data and the patient data.

2. The media of claim 1, further comprising displaying a diagnosis associated with a patient in each of the plurality of rooms.

3. The media of claim 1, further comprising receiving a request for additional information for one of the plurality of rooms.

4. The media of claim 1, further comprising receiving an assignment to the hospital unit for a swing room.

5. The media of claim 1, further comprising providing a scalable view of the dashboard.

6. The media of claim 5, wherein the scalable view is automatically scaled in accordance with a number of the plurality of rooms associated with the hospital unit.

7. The media of claim 1, further comprising visually tracking, utilizing the dashboard, clinicians associated with the hospital unit.

8. The media of claim 1, further comprising masking confidential data.

9. The media of claim 8, further comprising enabling viewing of confidential data based on credentials associated with a user in proximity of the dashboard.

10. The media of claim 1, further comprising providing, utilizing a keypad on the touchscreen display, a comment section.

11. The media of claim 1, further comprising receiving one or more alerts associated with a patient in one of the plurality of rooms.

12. The media of claim 11, further comprising presenting one or more visual cues on the dashboard associated with the plurality of rooms.

13. The media of claim 11, wherein the one or more alerts are device alerts or special care indicators.

14. The media of claim 11, further comprising receiving special rules related to the display on the dashboard of alerts based on location and importance.

15. The media of claim 11, further comprising displaying a summary listing of alerts by type related to each patient in the hospital unit according to a selected timeframe.

16. A computer system that facilitates automatically populating a dashboard, the computer system comprising a processor coupled to a computer storage medium, the computer storage medium having stored thereon a plurality of computer software components executable by the processor, the computer software components comprising:
a display component for displaying, on a touchscreen monitor, a dashboard associated with a plurality of rooms in a hospital unit;
an aggregate data component for receiving aggregate data associated with the plurality of rooms;
a population component for automatically populating the dashboard, in real-time, with the aggregate data;
an alert component for receiving one or more alerts associated with a patient in one of the plurality of rooms;
a visual cue component for displaying, on the dashboard, one or more visual cues associated with the plurality of rooms.

17. The system of claim 14, further comprising a tracking component for visually tracking, utilizing the dashboard, clinicians associated with the hospital unit.

18. The system of claim 14, further comprising a proximity component for enabling viewing of confidential data based on credentials associated with a user in proximity of the dashboard.

19. Computer storage media having computer-executable instructions embodied thereon that, when executed, produce a graphical user interface (GUI) to facilitate utilizing an automatically populated dashboard, the GUI comprising:
a first display area configured to display a dashboard associated with a plurality of rooms in a hospital unit;
a second display area configured to display aggregate data associated with the plurality of rooms including unit description, current shift, charge nurse, patient data, clinician names, and clinician numbers;
a third display area configured to display a comment section;
a fourth display area configured to display a set of filters that can be used to filter the dashboard to display only those rooms in accordance with a selected filter;
a fifth display area configured to display a header associated with one of the plurality of rooms including a room location and the name, sex, age, and length of stay of a patient;
a sixth display area configured to display caregivers associated with one of the plurality of rooms;
a seventh display area configured to display allergies associated with the patient;
an eighth display area configured to display care priorities associated with the patient;
a ninth display area configured to display a diagnosis associated with the patient; and
a tenth display area configured to display an alert history associated with the patient.

20. The GUI of claim 17, an eleventh display area configured to display visual cues on the dashboard associated with the plurality of rooms.
